(19) United States
(12) Patent Application Publication
(10) Pub. No.: US 2026/0181651 A1
(43) Pub. Date: Jun. 25, 2026

(54) METHODS AND APPARATUSES FOR RESOURCE ALLOCATION

(71) Applicant: Lenovo (Beijing) Limited, Beijing (CN)

(72) Inventors: Ruixiang Ma, Beijing (CN); Yuantao Zhang, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 19/125,704

(22) PCT Filed: Nov. 4, 2022
(86) PCT No.: PCT/CN2022/130012

§ 371 Date: Apr. 29, 2025

(51) Int. Cl. H04W 72/23; H04L 5/14

(52) U.S. Cl. CPC H04W 72/23; H04L 5/14

(57) ABSTRACT

Embodiments of the present disclosure relate to methods and apparatuses for resource allocation. According to some embodiments of the disclosure, a UE may: receive a resource allocation indication(s) from a base station (BS), wherein the resource allocation indication(s) indicates frequency domain locations and time domain locations of a first resource and a second resource; and determine a resource for an uplink (UL) transmission in a first time unit according to a type of symbol(s) of the time domains locations in the first time unit or a type(s) of symbols of the first time unit.

### TECHNICAL FIELD

Embodiments of the present disclosure generally relate to wireless communication technology, and more particularly to resource allocation in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a base station (BS) and a user equipment (UE) may communicate via downlink (DL) channels and uplink (UL) channels (e.g., a physical uplink shared channel (PUSCH) and a physical uplink control channel (PUCCH)). A UE may receive resource configurations for UL transmissions and may need to determine a resource for a UL transmission (e.g., a PUSCH or a PUCCH) before transmitting the UL transmission.

The industry desires technologies for facilitating the resource allocation and determination of a UL transmission in a communication system.

### SUMMARY

Some embodiments of the present disclosure provide a user equipment (UE). The UE may include a transceiver, and a processor coupled to the transceiver. The processor may be configured to: receive a resource allocation indication(s) from a base station (BS), wherein the resource allocation indication(s) indicates frequency domain locations and time domain locations of a first resource and a second resource; and determine a resource for an uplink (UL) transmission in a first time unit according to a type of symbol(s) of the time domains locations in the first time unit or a type(s) of symbols of the first time unit.

In some embodiments of the present disclosure, the UL transmission is a physical uplink shared channel (PUSCH) transmission or physical uplink control channel (PUCCH) transmission.

In some embodiments of the present disclosure, the type of symbols includes at least one of subband full duplex (SBFD), flexible, or UL.

In some embodiments of the present disclosure, in the case that the type of all symbols of the time domain locations in the first time unit is SBFD, the first resource is determined as the resource for the UL transmission in the first time unit. In some embodiments of the present disclosure, in the case that the type of all symbols of the time domain locations in the first time unit is UL or flexible, the second resource is determined as the resource for the UL transmission in the first time unit.

In some embodiments of the present disclosure, in the case that the type of symbols of the time domain locations in the first time unit includes two or more types, determining the resource for the UL transmission in the first time unit according to a type of symbol(s) of the time domains locations in the first time unit includes one of the followings: determining one of the first resource and the second resource as the resource for the UL transmission in the first time unit according to a type of a predefined symbol of the time domain locations in the first time unit; determining the first resource or second resource as the resource for the UL transmission in the first time unit; determining one of the first resource and the second resource as the resource for the UL transmission in the first time unit according to a second indication; determining to cancel the UL transmission in the first time unit; determining to transmit repetitions of the UL transmission in the first time unit, wherein the resource for the repetitions includes parts of the first resource and parts of the second resource; and determining the resource for the UL transmission includes parts of the first resource and parts of the second resource.

In some embodiments of the present disclosure, in the case that there is at least one subband full duplex (SBFD) symbol within the time domain locations, the first resource is determined as the resource for the UL transmission in the first time unit; otherwise, the second resource is determined as the resource for the UL transmission in the first time unit.

In some embodiments of the present disclosure (including, for example, all of the foregoing embodiments), the time domain locations of the first resource and the second resource in the first time unit are same.

In some embodiments of the present disclosure, determining the resource for the UL transmission in the first time unit according to a type of symbol(s) of the time domains locations in the first time unit comprises: determining one of the first resource and the second resource as the resource for the UL transmission in the first time unit according to a type of a predefined symbol of the time domain locations in the first time unit.

In some embodiments of the present disclosure, a type(s) of symbols of the time domain locations of the first resource and the second resource includes one of subband full duplex (SBFD), UL, flexible.

In some embodiments of the present disclosure, the processor is further configured to cancel the UL transmission in the first time unit in the case that the determined resource for the UL transmission in the first time unit overlaps a downlink (DL) subband or a DL symbol.

In some embodiments of the present disclosure, the time domain locations of the first resource and the second resource in the first time unit are same.

In some embodiments of the present disclosure, determining the resource for the UL transmission in the first time unit includes determining a valid resource from the first resource and the second resource as the resource for the UL transmission in the first time unit.

In some embodiments of the present disclosure, the valid resource is a resource that does not overlap a downlink (DL) subband or a DL symbol in the first time unit, or is not a dedicated resource for a certain UL transmission.

In some embodiments of the present disclosure, the determined resource for the UL transmission in the first time unit is one of the followings: a resource with more physical resources between the first resource and the second resource; a determined resource according to a type of a predefined symbol of the time domain locations of the first resource and the second resource; or the first resource or the second resource.

In some embodiments of the present disclosure, in the case that the type of the predefined symbol is SBFD, the first resource is determined as the resource for the UL transmission in the first time unit. In some embodiments of the present disclosure, in the case that the type of the predefined symbol is UL or flexible, the second resource is determined as the resource for the UL transmission in the first time unit.

In some embodiments of the present disclosure, the predefined symbol is a starting symbol or an ending symbol of the time domain locations of the first resource and the second resources.

In some embodiments of the present disclosure, in the case that a type of at least one symbol of the first time unit is subband full duplex (SBFD), the first resource is determined as the resource for the UL transmission in the first time unit. In some embodiments of the present disclosure, in the case that a type of each symbol of the first time unit is either flexible or UL, the second resource is determined as the resource for the UL transmission in the first time unit.

In some embodiments of the present disclosure, the type(s) of symbols of the first time unit includes one of subband full duplex (SBFD), UL, flexible. In some embodiments of the present disclosure, in the case that the type(s) of symbols of the first time unit is SBFD, the first resource is determined as the resource for the UL transmission in the first time unit. In some embodiments of the present disclosure, in the case that the type(s) of symbols of the first time unit is either flexible or UL, the second resource is determined as the resource for the UL transmission in the first time unit.

In some embodiments of the present disclosure, the UL transmission in the first time unit is a repetition for a certain UL transmission.

In some embodiments of the present disclosure, the UL transmission is a first repetition for a certain UL transmission, and the processor is further configured to determine that a resource for a repetition of the certain UL transmission in a following time unit is same as the resource for the UL transmission in the first time unit.

In some embodiments of the present disclosure, the first resource is for a UL transmission in a subband full duplex (SBFD) symbol or slot and the second resource is for a UL transmission in a non-SBFD symbol or slot.

Some embodiments of the present disclosure provide a user equipment (UE). The UE may include a transceiver, and a processor coupled to the transceiver. The processor may be configured to: receive a resource allocation indication(s) from a base station (BS), wherein the resource allocation indication(s) indicates frequency domain locations and time domain locations of a first resource and a second resource; and receive a second indication from the BS, which indicates whether the first resource or the second resource is used for a uplink (UL) transmission in a first time unit.

In some embodiments of the present disclosure, the first resource is for a UL transmission in a subband full duplex (SBFD) symbol or slot and the second resource is for a UL transmission in a non-SBFD symbol or slot.

Some embodiments of the present disclosure provide a base station (BS). The BS may include a transceiver, and a processor coupled to the transceiver. The processor may be configured to: transmit a resource allocation indication(s) to a user equipment (UE), wherein the resource allocation indication(s) indicates frequency domain locations and time domain locations of a first resource and a second resource; and determine a resource for a UL transmission in a first time unit according to a type of symbol(s) of the time domains locations in the first time unit or a type(s) of symbols of the first time unit.

In some embodiments of the present disclosure, the UL transmission is a physical uplink shared channel (PUSCH) transmission or physical uplink control channel (PUCCH) transmission.

In some embodiments of the present disclosure, the type of symbols includes at least one of subband full duplex (SBFD), flexible, or UL.

In some embodiments of the present disclosure, in the case that the type of all symbols of the time domain locations in the first time unit is SBFD, the first resource is determined as the resource for the UL transmission in the first time unit. In some embodiments of the present disclosure, in the case that the type of all symbols of the time domain locations in the first time unit is UL or flexible, the second resource is determined as the resource for the UL transmission in the first time unit.

In some embodiments of the present disclosure, in the case that the type of symbols of the time domain locations in the first time unit includes two or more types, determining the resource for the UL transmission in the first time unit according to a type of symbol(s) of the time domains locations in the first time unit include one of the followings: determining one of the first resource and the second resource as the resource for the UL transmission in the first time unit according to a type of a predefined symbol of the time domain locations in the first time unit; determining the first resource or second resource as the resource for the UL transmission in the first time unit; determining one of the first resource and the second resource as the resource for the UL transmission in the first time unit according to a second indication; determining that the UL transmission in the first time unit is canceled; determining to receive repetitions of the UL transmission in the first time unit, wherein the resource for the repetitions includes parts of the first resource and parts of the second resource; and determining the resource for the UL transmission includes parts of the first resource and parts of the second resource.

In some embodiments of the present disclosure, in the case that there is at least one subband full duplex (SBFD) symbol within the time domain locations, the first resource is determined as the resource for the UL transmission in the first time unit; otherwise, the second resource is determined as the resource for the UL transmission in the first time unit.

In some embodiments of the present disclosure, determining the resource for the UL transmission in the first time unit according to a type of symbol(s) of the time domains locations in the first time unit comprises: determining one of the first resource and the second resource as the resource for the UL transmission in the first time unit according to a type of a predefined symbol of the time domain locations in the first time unit.

In some embodiments of the present disclosure, a type(s) of symbols of the time domain locations of the first resource and the second resource includes one of subband full duplex (SBFD), UL, flexible.

In some embodiments of the present disclosure, the processor is further configured to determine that the UL transmission in the first time unit is canceled in the case that the determined resource for the UL transmission in the first time unit overlaps a downlink (DL) subband or a DL symbol.

In some embodiments of the present disclosure, the time domain locations of the first resource and the second resource in the first time unit are same.

In some embodiments of the present disclosure, determining the resource for the UL transmission in the first time unit includes determining a valid resource from the first resource and the second resource as the resource for the UL transmission in the first time unit.

In some embodiments of the present disclosure, the valid resource is a resource that does not overlap a downlink (DL) subband or a DL symbol in the first time unit, or is not a dedicated resource for a certain UL transmission.

In some embodiments of the present disclosure, the determined resource for the UL transmission in the first time unit is one of the followings: a resource with more physical resources between the first resource and the second resource; a determined resource according to a type of a predefined symbol of the time domain locations of the first resource and the second resource; or the first resource or the second resource.

In some embodiments of the present disclosure, in the case that the type of the predefined symbol is SBFD, the first resource is determined as the resource for the UL transmission in the first time unit. In some embodiments of the present disclosure, in the case that the type of the predefined symbol is UL or flexible, the second resource is determined as the resource for the UL transmission in the first time unit.

In some embodiments of the present disclosure, the predefined symbol is a starting symbol or an ending symbol of the time domain locations of the first resource and the second resources.

In some embodiments of the present disclosure, in the case that a type of at least one symbol of the first time unit is subband full duplex (SBFD), the first resource is determined as the resource for the UL transmission in the first time unit. In some embodiments of the present disclosure, in the case that a type of each symbol of the first time unit is either flexible or UL, the second resource is determined as the resource for the UL transmission in the first time unit.

In some embodiments of the present disclosure, the type(s) of symbols of the first time unit includes one of subband full duplex (SBFD), UL, flexible. In some embodiments of the present disclosure, in the case that the type(s) of symbols of the first time unit is SBFD, the first resource is determined as the resource for the UL transmission in the first time unit. In some embodiments of the present disclosure, in the case that the type(s) of symbols of the first time unit is either flexible or UL, the second resource is determined as the resource for the UL transmission in the first time unit.

In some embodiments of the present disclosure, the UL transmission in the first time unit is a repetition for a certain UL transmission.

In some embodiments of the present disclosure, the UL transmission is a first repetition for a certain UL transmission, and the processor is further configured to determine that a resource for a repetition of the certain UL transmission in a following time unit is same as the resource for the UL transmission in the first time unit.

In some embodiments of the present disclosure, the first resource is for a UL transmission in a subband full duplex (SBFD) symbol or slot and the second resource is for a UL transmission in a non-SBFD symbol or slot.

Some embodiments of the present disclosure provide a base station (BS). The BS may include a transceiver, and a processor coupled to the transceiver. The processor may be configured to: transmit a resource allocation indication(s) to a user equipment (UE), wherein the resource allocation indication(s) indicates frequency domain locations and time domain locations of a first resource and a second resource; and transmit a second indication to the UE, wherein the second indication indicates whether the first resource or the second resource is used for a uplink (UL) transmission in a first time unit.

In some embodiments of the present disclosure, the first resource is for a UL transmission in a subband full duplex (SBFD) symbol or slot and the second resource is for a UL transmission in a non-SBFD symbol or slot.

Some embodiments of the present disclosure provide a method performed by a UE. The method may include: receiving a resource allocation indication(s) from a base station (BS), wherein the resource allocation indication(s) indicates frequency domain locations and time domain locations of a first resource and a second resource; and determining a resource for a uplink (UL) transmission in a first time unit according to a type of symbol(s) of the time domains locations in the first time unit or a type(s) of symbols of the first time unit.

Some embodiments of the present disclosure provide a method performed by a UE. The method may include: receiving a resource allocation indication(s) from a base station (BS), wherein the resource allocation indication(s) indicates frequency domain locations and time domain locations of a first resource and a second resource; and receiving a second indication from the BS, which indicates whether the first resource or the second resource is used for a uplink (UL) transmission in a first time unit.

Some embodiments of the present disclosure provide a method performed by a BS. The method may include: transmitting a resource allocation indication(s) to a user equipment (UE), wherein the resource allocation indication(s) indicates frequency domain locations and time domain locations of a first resource and a second resource; and determining a resource for a uplink (UL) transmission in a first time unit according to a type of symbol(s) of the time domains locations in the first time unit or a type(s) of symbols of the first time unit.

Some embodiments of the present disclosure provide a method performed by a BS. The method may include: transmitting a resource allocation indication(s) to a user equipment (UE), wherein the resource allocation indication(s) indicates frequency domain locations and time domain locations of a first resource and a second resource; and transmitting a second indication to the UE, wherein the second indication indicates whether the first resource or the second resource is used for a uplink (UL) transmission in a first time unit.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary time domain resource allocation for a PUSCH with PUSCH repetition Type A scheme in accordance with some embodiments of the present disclosure;

FIGS. 3A and 3B illustrate an exemplary time domain resource allocation for a PUSCH with PUSCH repetition Type B scheme in accordance with some embodiments of the present disclosure;

FIG. 4 illustrates an exemplary time domain resource allocation for a PUSCH with enhanced PUSCH repetition Type A scheme in accordance with some embodiments of the present disclosure;

FIG. 5 illustrates an exemplary time domain resource allocation for a PUSCH with TB processing over multi-slot (TBOMS) PUSCH scheme in accordance with some embodiments of the present disclosure;

FIGS. 6A and 6B illustrate exemplary slot formats in accordance with some embodiments of the present disclosure;

FIG. 7 illustrates an exemplary sub-band full duplex scheme in accordance with some embodiments of the present disclosure;

FIGS. 8-9B illustrate exemplary resource allocations for a UL transmission in accordance with some embodiments of the present disclosure;

FIG. 10 illustrates a flow chart of an exemplary procedure for determining a resource for a UL transmission in accordance with some embodiments of the present disclosure;

FIGS. 11 and 12 illustrate exemplary schematic diagram for determining a resource for a UL transmission in accordance with some embodiments of the present disclosure;

FIG. 13 illustrates a flow chart of an exemplary procedure for determining a resource for a UL transmission in accordance with some embodiments of the present disclosure; and

FIG. 14 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

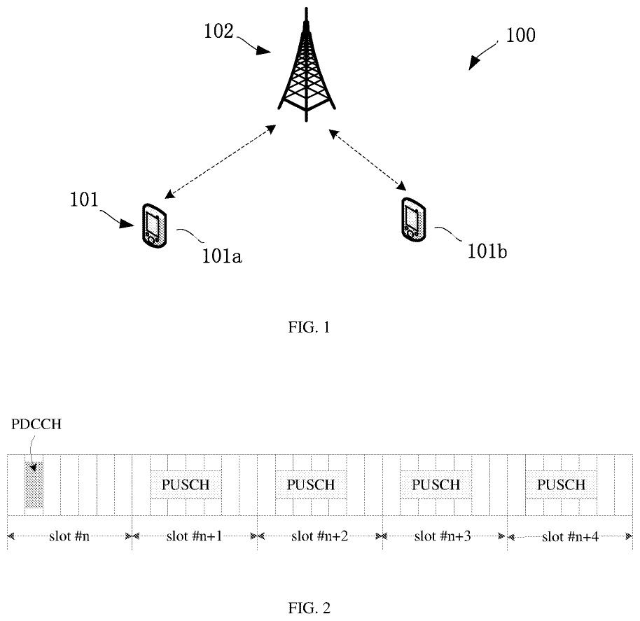

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

As mentioned above, a BS and a UE may communicate via DL channels and UL channels. For example, in some embodiments of the present disclosure, a PUSCH transmission can be dynamically scheduled by a UL grant in a downlink control information (DCI) format, or can correspond to a configured grant (CG) (e.g., CG Type 1 or CG Type 2). In some examples, the CG Type 1 PUSCH transmission may be semi-statically configured to operate in response to the reception of a higher layer parameter (e.g., an RRC parameter configuredGrantConfig including rrc-ConfiguredUplinkGrant as specified in 3GPP specifications), without the detection of a UL grant in a DCI format. In some examples, the CG Type 2 PUSCH transmission may be semi-persistently scheduled by a UL grant in a valid activation DCI format after the reception of a higher layer parameter (e.g., an RRC parameter configuredGrantConfig not including rrc-ConfiguredUplinkGrant as specified in 3GPP specifications).

Before a UE transmits a PUSCH, for example, a dynamically scheduled PUSCH or a CG PUSCH, the UE may receive a resource allocation assignment (e.g., frequency domain resource allocation assignment and time domain resource assignment) from a BS to determine the frequency and time domain resource of the PUSCH.

In some embodiments of the present disclosure, for a dynamically scheduled PUSCH and a CG Type 2 PUSCH, a UE may determine the frequency domain resource assignment according to a resource allocation field in a detected physical downlink control channel (PDCCH) carrying DCI (e.g., the DCI scheduling the dynamically scheduled PUSCH or the activation DCI). For a CG Type 1 PUSCH, a higher layer parameter (e.g., an RRC parameter frequencyDomainAllocation in configuredGrantConfig as specified in 3GPP specifications) may indicate the frequency domain resource assignment applied to the PUSCH transmission. The frequency domain resource assignment may indicate to a scheduled UE a set of resource blocks (RB) within the active bandwidth part.

In some embodiments of the present disclosure, for a dynamically scheduled PUSCH transmission, the scheduling DCI format may include a time domain resource assignment field to indicate the time domain resource of the PUSCH. For example, the value of the time domain resource assignment field may provide a row index (e.g., denoted as m+1) to a time domain resource allocation table. The used resource allocation table may be predefined (e.g., in 3GPP specifications) or may be configured by a higher layer parameter. The indexed row may indicate a slot offset (e.g., denoted as K₂), which may indicate the number of slots between the slot where the DCI format is received and the slot where the PUSCH is to be transmitted (denoted as PUSCH transmission slot). The indexed row may also indicate a start and length indicator (denoted as SLIV) or directly indicate the start symbol (denoted as S) and the allocation length (which may also be referred to as the number of consecutive symbols and is denoted as L), which indicates the location of the PUSCH transmission in the PUSCH transmission slot. The indexed row may indicate the number of repetitions (for example, in the case that the parameter numberOfRepetitions is present in the resource allocation table) to be applied in the PUSCH transmission.

In some embodiments of the present disclosure, for a CG Type 1 PUSCH transmission, a higher layer parameter (e.g., an RRC parameter timeDomainAllocation as specified in 3GPP specifications) with a value of m may provide a row index m+1 pointing to a time domain resource allocation table. Similar to the dynamically scheduled PUSCH transmission as described above, the time domain resource allocation of the PUSCH transmission can be determined based on the indexed row. For example, the start symbol and length of the PUSCH transmission can be determined based on a start and length indicator or the start symbol and the allocation length indicated in the indexed row.

In some embodiments of the present disclosure, for CG Type 2 PUSCH transmissions, the time domain resource allocation may follow the UL grant in the activation DCI. For example, a UE may determine the time domain resource assignment according to a resource allocation field in the DCI.

In some embodiments of the present disclosure, a plurality of schemes for resource allocation in the time domain may be employed for a PUSCH, including a dynamically scheduled PUSCH or CG PUSCH. For example, the plurality of schemes may include PUSCH repetition type A, PUSCH repetition type B, enhancements on PUSCH repetition type A, and TB processing over a multi-slot PUSCH (TBOMS). A higher layer parameter (e.g., an RRC parameter) may indicate which scheme is used for a certain PUSCH transmission. The details regarding the time domain resource allocation for these schemes are described in the following text.

In some embodiments of the present disclosure, for PUSCH repetition type A, the starting symbol S relative to the start of the PUSCH transmission slot, and the number of consecutive symbols L counting from the symbol S allocated for the PUSCH can be determined from the start and length indicator SLIV of the indexed row. For example, the following method may be employed.

```
If (L − 1) ≤ 7 then
  SLIV = 14 · (L − 1) + S
else
  SLIV = 14 · (14 − L + 1) + (14 − 1 − S)
where 0 < L ≤ 14 − S .
```

In some embodiments of the present disclosure, the UE may further determine the number of repetitions (denoted as K) of a PUSCH transmission.

In some embodiments, as described above, the number of repetitions K may be determined based on a parameter (e.g., numberOfRepetitions) in the resource allocation table. In some embodiments, when the parameter is not present in the table, the number of repetitions K may be determined based on a higher layer parameter (e.g., pusch-AggregationFactor as specified in 3GPP specifications) if configured. In some embodiments, when the parameter is not present in the table and the higher layer parameter is not configured, the number of repetitions K may be equal to 1.

For example, when transmitting a PUSCH scheduled by a DCI format 0_1 or 0_2 in a PDCCH with a cyclic redundancy check (CRC) scrambled with a cell-radio network temporary identifier (C-RNTI), modulation and coding scheme (MCS) C-RNTI (MCS-C-RNTI), or configured scheduling RNTI (CS-RNTI) with a new data indicator (NDI)=1, the number of repetitions K may be equal to numberOfRepetitions if present in the table; or the number of repetitions K may be equal to pusch-AggregationFactor if configured; otherwise, the number of repetitions K may be equal to 1.

In some embodiments, for a CG PUSCH, the number of (nominal) repetitions K to be applied to the transmitted PUSCH or transport block may be provided by the indexed row in the time domain resource allocation table (e.g., when numberOfRepetitions is present in the table); otherwise, the number of (nominal) repetitions K may be provided by a configured higher layer parameter (e.g., repK as specified in 3GPP specifications).

For PUSCH repetition Type A, in the case of K>1, the same symbol allocation may be applied across K consecutive slots, for example, starting from the determined PUSCH transmission slot. For example, the UE may repeat a TB across the K consecutive slots applying the same symbol allocation in each slot.

For example, referring to FIG. 2, a UE may receive, in slot #n, a PDCCH carrying a DCI format scheduling a PUSCH transmission. It is assumed that a slot includes 14 symbols indexed from symbol 0 to symbol 13. It is assumed that PUSCH repetition type A is configured to be applied to the PUSCH transmission.

The DCI format may indicate a row from a time domain resource allocation table. Assuming that the indicated row indicates K₂=1 and K=4, the UE can determine an initial transmission (or initial repetition) of the PUSCH transmission in slot #n+1, and 3 repetitions of the PUSCH transmission in slots #n+2 to #n+4. Assuming that the indicated row indicates S=2 and L=8, the UE can determine that each of the four repetitions of the PUSCH transmission may occupy symbol 2 to symbol 9 in the corresponding slot.

In some embodiments of the present disclosure, for PUSCH repetition Type A, a PUSCH transmission in a slot of a multi-slot PUSCH transmission may be omitted if any symbol of the PUSCH overlaps a set of symbols of the slot that are indicated to a UE as downlink. For example, a higher layer parameter (e.g., tdd-UL-DL-ConfigCommon or tdd-UL-DL-ConfigDedicate as specified in 3GPP specifications) may be configured for a UE to indicate whether a symbol of a slot is downlink or not.

In some embodiments of the present disclosure, for PUSCH repetition type B, the nominal repetitions of a PUSCH transmission may be consecutive in the time domain. In some examples, the number of (nominal) repetitions K may be determined based on a higher layer parameter (e.g., numberOfRepetitions).

For the n^{th} (nominal) repetition (where n=0, . . . , K−1), the slot where the (nominal) repetition starts and the slot where the (nominal) repetition ends can be determined based on the slot where the PUSCH transmission starts (denoted as Kₛ), the number of symbols per slot

$$( denoted as {N}_{symb}^{slot} ) .$$

the start symbol S, and the allocation length L. The starting symbol of the n^{th} (nominal) repetition relative to the start of the slot where the repetition starts and the ending symbol of the repetition relative to the start of the slot where the repetition ends can be determined based on the number of symbols per slot

$${N}_{symb}^{slot} ,$$

the start symbol S, and the allocation length L.

For example, the slot where the n^{th} nominal repetition starts and the starting symbol of the n^{th} nominal repetition relative to the start of the slot can be determined according to the following formulas respectively.

$${K}_{s} + ⌊ \frac{S + n \cdot L}{{N}_{s y m b}^{slot}} ⌋ \qquad ( 1 )$$

$$mod ( S + n \cdot L , {N}_{s y m b}^{slot} ) \qquad ( 2 )$$

For example, the slot where the n^{th} nominal repetition ends and the ending symbol of the n^{th} nominal repetition relative to the start of the slot can be determined according to the following formulas respectively.

$${K}_{s} + ⌊ \frac{S + ( n + 1 ) \cdot L - 1}{{N}_{s y m b}^{slot}} ⌋ \qquad ( 3 )$$

$$mod ( S + ( n + 1 ) \cdot L - 1 , {N}_{s y m b}^{slot} ) \qquad ( 4 )$$

The slot Kₛ where the PUSCH transmission starts and the starting symbol S and the allocation length L (e.g., counting from the symbol S) allocated for the PUSCH may be provided by the indexed row of the resource allocation table. For example, starting symbol S and the allocation length L may be provided by startSymbol and length in the table, respectively.

In some embodiments of the present disclosure, for PUSCH repetition Type B, a symbol that is indicated as downlink (e.g., by a higher layer parameter tdd-UL-DL-ConfigCommon, or tdd-UL-DL-ConfigDedicated) may be considered as an invalid symbol for a PUSCH repetition Type B transmission.

For example, after determining the invalid symbol(s) for a PUSCH repetition type B transmission for each of the K nominal repetitions, the remaining symbols are considered as potentially valid symbols for the PUSCH repetition Type B transmission. If the number of potentially valid symbols for a PUSCH repetition type B transmission is greater than zero for a certain nominal repetition, the nominal repetition may include one or more actual repetitions, wherein each actual repetition may include a consecutive set of all the potentially valid symbols that can be used for the PUSCH repetition Type B transmission within a slot. An actual repetition with a single symbol may be omitted except for the case of L=1.

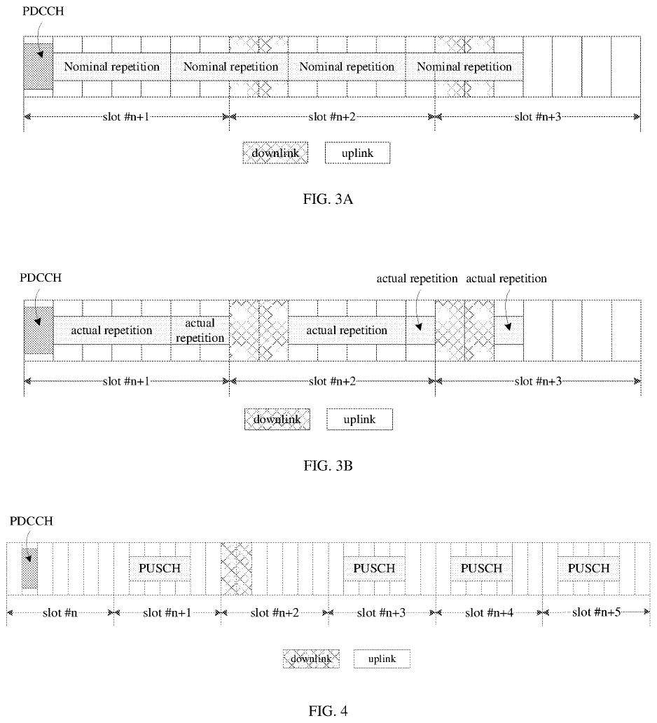

For example, referring to FIG. 3A, a UE may receive, in slot #n+1, a PDCCH carrying a DCI format scheduling a PUSCH transmission. It is assumed that a slot includes 14 symbols indexed from symbol 0 to symbol 13. It is assumed that PUSCH repetition type B is configured to be applied to the PUSCH transmission. The DCI format may indicate a row from a time domain resource allocation table. Assuming that the indicated row indicates K₂=0, the UE can determine the PUSCH transmission starts in slot #n+1.

Assuming that the indicated row indicates S=2, L=8, K=4, the UE can determine four nominal repetitions according to the above-mentioned formulas (1) to (4). For example, as shown in FIG. 3A, a first nominal repetition may start from symbol 2 in slot #n+1 and end at symbol 9 in slot #n+1; a second nominal repetition may start from symbol 10 in slot #n+1 and end at symbol 3 in slot #n+2; a third nominal repetition may start from symbol 4 in slot #n+2 and end at symbol 11 in slot #n+2; and a fourth nominal repetition may start from symbol 12 in slot #n+2 and end at symbol 5 in slot #n+3.

In some examples, it is assumed that symbols 0-3 of slot #n+2 and slot #n+3 are indicated as downlink. In such case, based on the four nominal repetitions as shown in FIG. 3A, five actual repetitions may be determined as shown in FIG. 3B considering the downlink symbols. For example, as shown in FIG. 3B, a first actual repetition may start from symbol 2 in slot #n+1 and end at symbol 9 in slot #n+1; a second actual repetition may start from symbol 10 in slot #n+1 and end at symbol 13 in slot #n+1; a third actual repetition may start from symbol 4 in slot #n+2 and end at symbol 11 in slot #n+2; a fourth actual repetition may start from symbol 12 in slot #n+2 and end at symbol 13 in slot #n+2; and a fifth actual repetition may start from symbol 4 in slot #n+3 and end at symbol 5 in slot #n+3.

In some embodiments of the present disclosure, the time domain resource allocation for enhanced PUSCH repetition type A may be the same as that for PUSCH repetition type A, except that the number of repetitions is counted on the basis of available slots.

In some embodiments of the present disclosure, a slot may be determined as unavailable if at least one of the symbols indicated by the time domain resource allocation for a PUSCH in the slot overlaps the symbol not intended for UL transmissions. In some embodiments of the present disclosure, a semi-static flexible symbol (e.g., configured by tdd-UL-DL-ConfigCommon or tdd-UL-DL-ConfigDedicated) may be considered as available.

For example, referring FIG. 4, a UE may receive, in slot #n, a PDCCH carrying a DCI format scheduling a PUSCH transmission. The DCI format may indicate a row from a time domain resource allocation table. It is assumed that a slot includes 14 symbols indexed from symbol 0 to symbol 13.

In some embodiments, it is assumed that enhanced PUSCH repetition type A is configured to be applied to the PUSCH transmission. For example, assuming that the indicated row indicates K₂=1, S=2, L=8 and K=4 and symbols 0-3 of slot #n+2 are indicated as downlink symbols, the UE can determine an initial repetition of the PUSCH transmission in slot #n+1, and 3 repetitions of the PUSCH transmission in slots #n+3 to #n+5. The time domain resource for each of the 4 repetitions is the same in each of the four slots, that is, starting from symbol 2 and ending at symbol 9.

However, in the case that PUSCH repetition type A is configured to be applied to the PUSCH transmission. The UE may determine four (nominal) repetitions of the PUSCH transmission in slots #n+1 to #n+4 (e.g., as shown in FIG. 2). Among the four repetitions, the second repetition in slot #n+2 may be omitted due to the downlink symbols of slot #n+2.

In some embodiments of the present disclosure, the time domain resource determination for TBOMS can be performed in a similar manner as that for PUSCH repetition Type A or enhanced PUSCH repetition Type A, for example, by employing a time domain resource allocation table. For example, the number of slots K allocated for TBOMS may be determined according to a row index of a time domain resource allocation table (or time domain resource allocation list), and may be counted based on the available slots for UL transmission. The table can be configured via RRC signaling. The definition of the available slot described with respect to enhanced PUSCH repetition type A may apply here. The transmission in each of the K slots may be referred to as a transmission part of the TB carried by the PUSCH transmission.

For example, referring FIG. 5, a UE may receive, in slot #n, a PDCCH carrying a DCI format scheduling a PUSCH transmission. The DCI format may indicate a row from a time domain resource allocation table. It is assumed that a slot includes 14 symbols indexed from symbol 0 to symbol 13.

In some embodiments, it is assumed that TBOMS is configured to be applied to the PUSCH transmission. For example, assuming that the indicated row indicates K₂=1, S=2, L=8 and K=4 and symbols 0-3 of slot #n+2 are indicated as downlink symbols, the UE can determine 4 slots for the PUSCH transmission including slot #n+1 and slots #n+3 to #n+5. The time domain resource for a corresponding transmission part in each of slot #n+1 and slots #n+3 to #n+5 is the same, that is, starting from symbol 2 and ending at symbol 9.

In some embodiments of the present disclosure, a PUCCH may be transmitted to report uplink control information (UCI). The UCI types reported in a PUCCH may include, for example, hybrid automatic repeat request acknowledgement (HARQ-ACK) information, scheduling request (SR), link recovery request (LRR), and channel state information (CSI). UCI bits carried by a PUCCH may include HARQ-ACK information bits (if any), SR information bits (if any), LRR information bit (if any), and CSI bits (if any).

In some embodiments of the present disclosure, a UE may be provided with at least one set (e.g., up to four sets) of PUCCH resources (e.g., by PUCCH-Config). For example, a PUCCH resource set may be provided by a higher layer parameter (e.g., an RRC parameter PUCCH-ResourceSet as specified in 3GPP specifications) and may be associated with a PUCCH resource set index provided by a higher layer parameter (e.g., an RRC parameter pucch-ResourceSetId as specified in 3GPP specifications). A PUCCH resource set may indicate a set of PUCCH resource indexes provided by a higher layer parameter (e.g., an RRC parameter resourceList as specified in 3GPP specifications) that provides a set of PUCCH resource IDs (e.g., pucch-ResourceId as specified in 3GPP specifications used in a PUCCH resource set. A PUCCH resource set may indicate a maximum number of UCI information bits (e.g., maxPayloadSize as specified in 3GPP specifications) or a range of UCI information bits the UE can transmit using a PUCCH resource in the PUCCH resource set. A PUCCH resource set may include a plurality of resources (e.g., sixteen PUCCH resources), each of which may correspond to a PUCCH format, a first symbol, a duration, a physical resource block (PRB) offset (e.g., denoted as

$$R {B}_{B W P}^{offset}$$

in 3GPP specifications), and a cyclic shift index set for a PUCCH transmission.

In some embodiments of the present disclosure, to transmit UCI information bits (e.g., including HARQ-ACK information bits), a UE may first determine a PUCCH resource set from the at least one PUCCH resource set according to the number of the UCI information bits (e.g., O_{UCI} bits). Then, the UE may determine a PUCCH resource from the selected PUCCH resource set for transmitting the UCI information bits. For example, the UE may determine the PUCCH resource according to a PUCCH resource indicator (PRI) in a DCI format (e.g., the last DCI format associated with the UCI information bits).

In some embodiments of the present disclosure, a UE may be provided with a list of PUCCH resources (e.g., SPS-PUCCH-AN-List as specified in 3GPP specifications) for HARQ-ACK feedback corresponding to SPS PDSCHs. The UE may transmit UCI information bits that include only HARQ-ACK information bits in response to one or more SPS PDSCH receptions and SR (if any). In this case, the UE may determine a PUCCH resource from the list of PUCCH resources according to (only) the number of the UCI information bits (e.g., O_{UCI} bits).

In some embodiments of the present disclosure, a PUCCH resource in a PUCCH resource set or PUCCH resource list may be included in a slot or a sub-slot. A sub-slot can include, for example, 2 or 7 symbols.

In some embodiments of the present disclosure, a UE may first determine to transmit a PUCCH in a time unit (e.g., a slot or a sub-slot). For example, the UE may determine a slot for transmitting the PUCCH according to a DCI format. The DCI format may include a HARQ timing field indicating the time difference between the time unit used for PDSCH transmission and the time unit used for the corresponding PUCCH transmission carrying the HARQ-ACK feedback of the PDSCH transmission. Then, the UE may determine the PUCCH resource in the time unit according to the method as described above.

In some embodiments of the present disclosure, a time division duplex (TDD) slot format may include at least one of a DL symbol, a UL symbol and flexible symbol. “Flexible” means that a UE cannot make any assumptions on the transmission direction. In some embodiments, downlink control signal (e.g., PDCCH) may be monitored in flexible symbols. If a scheduling message is found, a UE may perform transmission or reception accordingly. The flexible symbols can also serve as a guard period for a UE to switch from DL reception to UL transmission, or vice versa.

In some embodiments of the present disclosure, a slot format can be determined by a common UL/DL configuration (e.g., cell tdd-UL-DL-ConfigCommon), which may be provided to the UE through system information. The cell common UL/DL configuration may include configurations of a transmission pattern.

For example, a cell common UL/DL configuration may indicate one or more of the following:
a slot configuration period of P msec (e.g., by dl-ul-transmission-periodicity)
a number of downlink slots dₛₗₒₜₛ (e.g., by nrofDownlinkSlots)
a number of downlink symbols d_{sym} (e.g., by nrofDownlinkSymbols)
a number of uplink slots uₛₗₒₜₛ (e.g., by nrofUplinkSlots) a number of uplink symbols u_{sym} (e.g., by nrofUplinkSymbols).

It is assumed that the slot configuration period of P msec includes S slots. The transmission pattern can be determined as: among the S slots, a first dₛₗₒₜₛ slots includes only downlink symbols and a last uₛₗₒₜₛ includes only uplink symbols; the d_{sym} symbols after the dₛₗₒₜₛ slots are downlink symbols; the u_{sym} symbols before the last uₛₗₒₜₛ are uplink symbols; and the remaining (S-dₛₗₒₜ-uₛₗₒₜ)*N_{sym}−d_{sym}−u_{sym} are flexible symbols, where N_{sym} is the number of symbols in a slot.

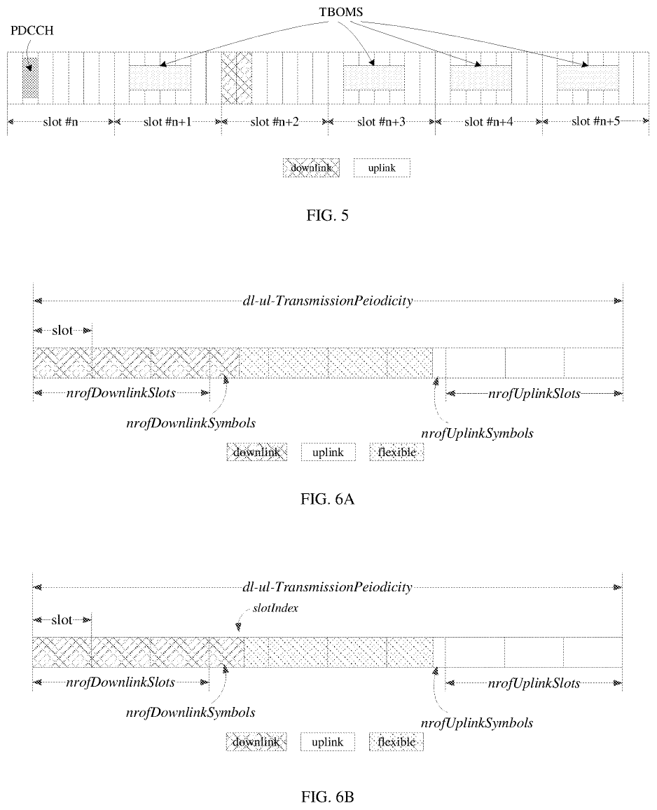

For example, assuming that subcarrier spacing (SCS) of 30 KHz is employed, and dl-ul-TransmissionPeiodicity=5 ms, nrofDownlinkSlots=3, nrofUplinkSlots=3, nrofDownlinkSymbols=7, and nrofUplinkSymbols=3, a slot format for 10 slots within the slot configuration period is shown in FIG. 6A. That is, among the 10 slots, the first 3 slots are DL slots, the first 7 symbols of the fourth slot are DL symbols, the last 3 slots are UL slots, the last 3 symbols of the last but three slot are UL symbols, and the remaining slots or symbols are flexible (i.e., a total of 46 flexible symbols). In this example, the 46 flexible symbols may be served as the guard period for DL to UL switching.

In some embodiments of the present disclosure, a UE may be further provided with a UE specific UL/DL configuration via RRC signaling (e.g., tdd-UL-DL-ConfigDedicated). In some embodiments, the UE specification configuration may override only flexible symbols per slot over the number of slots as provided by the cell common UL/DL configuration.

For example, a UE specific UL/DL configuration may indicate one or more of the following:
a set of slot configurations (e.g., by slotSpecificConfigurationsToAddModList)
for each slot configuration from the set of slot configurations
   a slot index for a slot (e.g., provided by slotIndex)
   a set of symbols for a slot (e.g., provided by symbols) where
      if symbols=allDownlink, all symbols in the slot are downlink
      if symbols=allUplink, all symbols in the slot are uplink
      if symbols=explicit, a number of downlink symbols (e.g., provided by nrofDownlinkSymbols) provides a number of downlink first symbols in the slot and a number of downlink symbols (e.g., provided by nrofUplinkSymbols) provides a number of uplink last symbols in the slot. If nrofDownlinkSymbols is not provided, there are no downlink first symbols in the slot and if nrofUplinkSymbols is not provided, there are no uplink last symbols in the slot. The remaining symbols in the slot are flexible.

For each slot having a corresponding index provided by the slot index (e.g., slotIndex) in the UE specific UL/DL configuration, the UE may apply a format according to the corresponding set of symbols (e.g., symbols) for the slot in the UE specific UL/DL configuration. The UE may not expect a UE specific UL/DL configuration to indicate a symbol that a cell common UL/DL configuration indicates as downlink (or uplink) as uplink (or downlink).

FIG. 6B shows an example slot format based on FIG. 6A. In FIG. 6B, a UE specific UL/DL configuration indicates: slotIndex=3, symbols=explicit, nrofDownlinkSymbols=8. That is, in FIG. 6B, the first 8 symbols of the 4th slot are DL symbols and the remaining 6 symbols of the 4th slot are flexible symbols.

In some embodiments of the present disclosure, the transmission directions of the flexible symbols can be indicated by a dynamic signaling. Such signaling may carry a slot format indicator (SFI) and may be received by a configured group of one or more devices (e.g., UEs). For example, a DCI format may indicate an SFI, which may change a transmission direction of a flexible symbol(s) configured by a UE specific UL/DL configuration into UL or DL.

In order to realize a superior data rate and reduce latency in a wireless system (e.g., 5G system), a spectrum on higher frequency band is inevitable. However, a big question is how to overcome coverage reduction on such carriers.

To solve the problem, a duplexing scheme that enables simultaneous use of downlink and uplink within a TDD carrier using a non-overlapped frequency resource (which may be referred to as “sub-band full duplex”) may be employed. The sub-band (also referred to as UL subband) may refer to a bandwidth part (BWP) of a serving cell of a UE or a part of a BWP of a serving cell of a UE. One intention of this scheme is to extend the duration over which uplink transmission can occur for improving uplink coverage and capacity. For example, a BS may simultaneously perform a downlink transmission and an uplink transmission (for example, on different UEs).

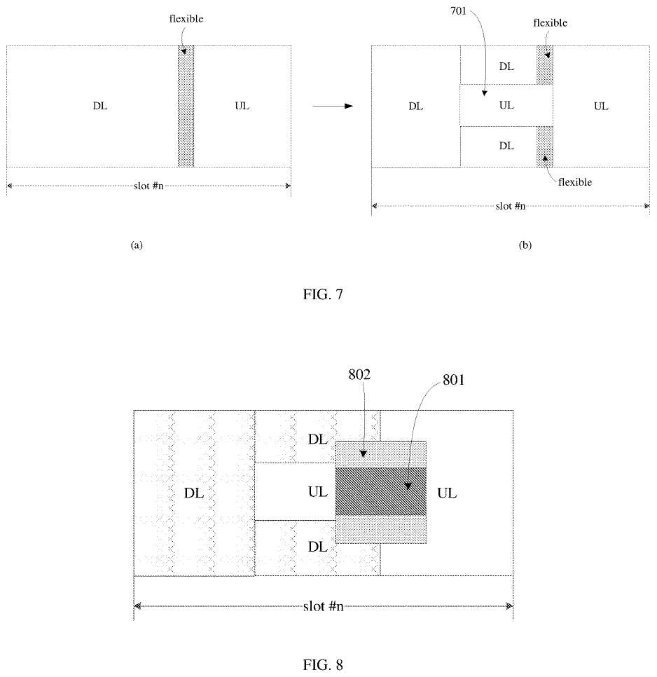

FIG. 7 illustrates an exemplary sub-band full duplex scheme in accordance with some embodiments of the present disclosure.

Referring to FIG. 7, a UE may determine a slot format (a) for slot #n according to, for example, a cell common UL/DL configuration, a UE specific UL/DL configuration, or an SFI. The UE may further receive signaling, which indicates a frequency domain resource and time domain resource of a UL sub-band for SBFD, which can override a DL symbol(s), a flexible symbol(s), or both. For example, the UE may be configured with a UL sub-band 701 and determine a slot format (b) for slot #n.

There may be four symbol types in a system adopting the sub-band full duplex scheme. The four types include DL, flexible, SBFD, and UL. For example, a DL or UL symbol may mean that the transmission direction on this symbol is DL or UL. For example, a flexible symbol may mean that a UE cannot make any assumptions on the transmission direction of this symbol. For example, an SBFD symbol may mean that this symbol can support simultaneous DL and UL transmissions. A symbol being SBFD symbol means that there could be at least two sub-bands with different transmission directions in this symbol, or a BS may simultaneously perform a downlink transmission and an uplink transmission in this symbol. It should be noted that another name may be used to denote such symbol. In the context of the present disclosure, a non-SBFD symbol may refer to a DL, flexible, or UL symbol.

The definitions of the four symbol types may also be applied to a slot. That is, a slot may be a DL, flexible, SBFD, or UL slot. For example, a DL or UL slot may mean that the transmission direction on this slot is DL or UL. For example, a flexible slot may mean that a UE cannot make any assumptions on the transmission direction of this slot. For example, an SBFD slot may refer to a slot where all symbols in the slot are SBFD symbols. In the context of the present disclosure, a non-SBFD slot may refer to a DL, flexible, or UL slot or a slot does not include any SBFD symbols.

As mentioned above, a resource indication may indicate UL resource for a UL transmission such as a PUCCH transmission or PUSCH transmission (including for example, a dynamic PUSCH, a CG PUSCH, PUSCH repetition type A, PUSCH repetition type B, enhanced PUSCH repetition type A, or TBOMS). The resource indication may indicate a single resource (or a single resource configuration) for the UL transmission which may include a plurality of symbols or slots.

However, considering that the available UL resource in SBFD slots or symbols and in UL slots or symbols are different, when the indicated UL resource is too big, then in SBFD symbols or slots, the indicated resource would overlap a DL sub-band; and when the indicated UL resource is too small, then it would have an impact on the resource utilization in normal UL symbols or slots. In such case, indicating a single resource for a UL transmission may not be adequate.

To solve this problem, in some embodiments of the present disclosure, more than one (e.g., two) resource or resource configuration may be indicated for a UL transmission (e.g., a PUSCH or PUCCH transmission). For example, one resource (or resource configuration) may be indicated for a UL transmission in an SBFD symbol(s) or slot(s) and another resource (or resource configuration) may be indicated for a UL transmission in a non-SBFD symbol(s) or slot(s). When a UE transmits a specific UL transmission, the UE may need to determine a resource for the specific UL transmission based on the two indicated resources (or resource configurations). Solutions may be required for determining the resource for the specific UL transmission based on the two indicated resources (or resource configurations).

For example, referring to FIG. 8, a UE may determine two PUSCH resources (e.g., resources 801 and 802) according to respective resource allocation indications. In the example of FIG. 8, resources 801 and 802 may have different frequency domain locations and the same time domain locations. It should be noted that resources 801 and 802 may have the same frequency domain locations or different time domain locations in some other examples. In the example of FIG. 8, compared with resource 801, resource 802 may include more physical resources.

In some embodiments, resource 801 may be indicated for a PUSCH transmission in an SBFD symbol or slot, and resource 802 may be indicated for a PUSCH transmission in a non-SBFD symbol or slot. However, the durations of resources 801 and 802 may span cross the UL symbols and SBFD symbols. Solutions may be required for determining a resource for the current PUSCH transmission based on resources 801 and 802.

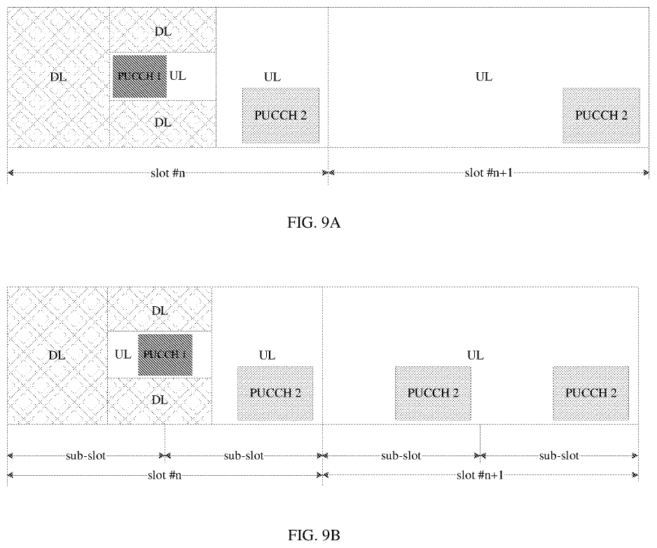

For example, referring to FIG. 9A, a UE may determine to transmit a PUCCH in slot #n. The UE may further determine two PUCCH resources in slot #n. For example, PUCCH resource 1 may be indicated for a PUCCH transmission in an SBFD symbol or slot, and PUCCH resource 2 may be indicated for a PUCCH transmission in a non-SBFD symbol or slot.

For example, referring to FIG. 9B, a UE may determine to transmit a PUCCH in the second sub-slot of slot #n. The UE may further determine two PUCCH resources in this sub-slot. For example, PUCCH resource 1 may be indicated for a PUCCH transmission in an SBFD symbol or slot, and PUCCH resource 2 may be indicated for a PUCCH transmission in a non-SBFD symbol or slot.

In both FIGS. 9A and 9B, solutions may be required for determining the resource for the current PUCCH transmission based on PUCCH resources 1 and 2. For example, in FIG. 9A, whether PUCCH resource 1 or PUCCH resource 2 in slot #n should be used for the current PUCCH transmission. For example, in FIG. 9B, whether PUCCH resource 1 or PUCCH resource 2 in the second sub-slot of slot #n should be used for the current PUCCH transmission since a part of PUCCH resource 1 is within the sub-slot.

Embodiments of the present disclosure provide solutions that can solve at least the above issues when separate resource configurations (e.g., separate PUSCH or PUCCH resource configurations) or separate resources are determined for SBFD and UL. For example, solutions for determining a resource for a UL transmission (e.g., a PUSCH or PUCCH transmission) based on the two resource configurations are provided. More details on the embodiments of the present disclosure will be illustrated in the following text in combination with the appended drawings.

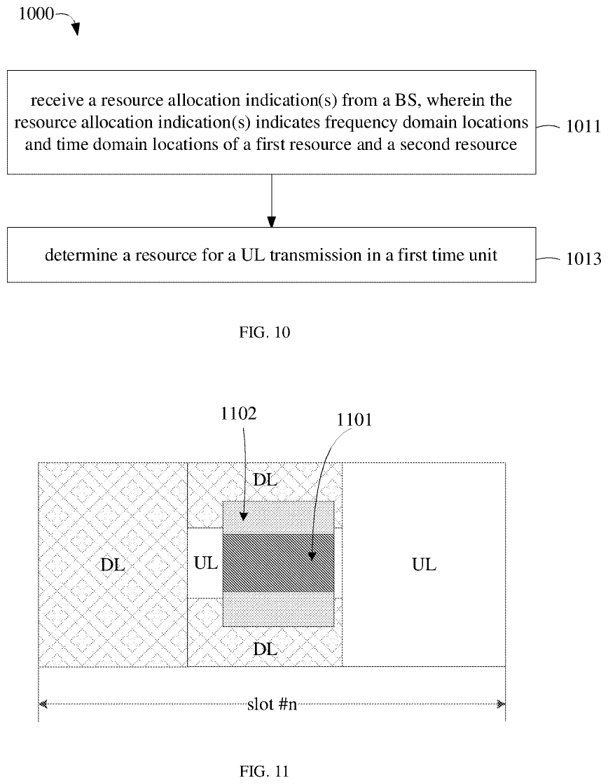

FIG. 10 illustrates a flow chart of exemplary procedure 1000 for determining a resource for a UL transmission in accordance with some embodiments of the present disclosure. Procedure 1000 may be implemented by a UE (e.g., UE 101 as shown in FIG. 1). Details described in all of the foregoing embodiments of the present disclosure are applicable for the embodiments shown in FIG. 10.

Referring to FIG. 10, in operation 1011, a UE may receive a resource allocation indication(s) from a BS, wherein the resource allocation indication(s) indicates frequency domain locations and time domain locations of a first resource and a second resource.

In some embodiments of the present disclosure, the first resource is for a UL transmission in an SBFD symbol or slot and the second resource is for a UL transmission in a non-SBFD symbol or slot. In some embodiments, the first resource may occupy a UL sub-band(s). For example, the first resource may be included in a UL sub-band of SBFD symbols, if any. In some embodiments, the frequency bandwidth of the first resource may be smaller than or equal to that of the second resource. For example, in slot #n, the determined first and second resources may be implemented as resources 801 and 802 in FIG. 8, respectively.

In some embodiments of the present disclosure, separate resource allocation indications may be employed to indicate the first resource and the second resource. In some examples, the resource allocation indication indicating the first resource and the resource allocation indication indicating the second resource may be carried in the same or different signaling. For example, the two resource allocation indications may be carried by a single RRC message, two separate RRC messages, one RRC message and a DCI format over a PDCCH, or two separate DCI formats. In some embodiments of the present disclosure, a single resource allocation indication may be used to indicate the first resource and the second resource.

In some embodiments of the present disclosure, the time domain locations of the first resource and the second resource may be the same or different.

In some embodiments of the present disclosure, the UL transmission is a PUSCH transmission.

In some embodiments, the resource allocation indication(s) may indicate two frequency domain locations for the first resource and the second resource respectively. In some embodiments, the resource allocation indication(s) may further indicate a single time domain location for both the first resource and the second resource. In some other embodiments, the resource allocation indication(s) may further indicate two time domain locations for the first resource and the second resource respectively. The starting symbols of the time domain locations of the first resource and the second resource may be the same or different, and the length of the time domain locations of the first resource and the second resource may be the same or different.

The method for indicating the time and frequency domain locations as described in previous text may apply here. For example, for dynamic PUSCH and CG Type 2 PUSCH, a scheduling DCI format or an activation DCI may include a frequency domain resource assignment field and a time domain resource assignment field. For example, for CG Type 1 PUSCH, RRC signaling may indicate a frequency domain resource assignment and a time domain resource assignment applied to the PUSCH.

In some embodiments of the present disclosure, the UL transmission is a PUCCH transmission.

In some embodiments, the resource allocation indication(s) may indicate two PUCCH resource sets associated with the same number of UCI bits, wherein one of the two PUCCH resource sets is for a PUCCH transmission in SBFD symbols or slots and the other is for a PUCCH transmission in UL non-SBFD symbols or slots. The UE can respectively determine two PUCCH resources from the two PUCCH resource sets based on the number of UCI bits to be transmitted.

In some embodiments, the resource allocation indication(s) may indicate a single time domain location and two frequency domain locations for a single PUCCH configuration. The first resource and the second resource may share the same time domain location and correspond to respective frequency domain locations. For example, the first resource and the second resource can be indicated by the UCI bit to be transmitted and a single PRI.

In some embodiments, the resource allocation indication(s) may indicate two time domain locations and two frequency domain locations for a single PUCCH configuration. The first resource and the second resource may correspond to respective time domain locations and respective frequency domain locations. For example, the first resource and the second resource can be indicated by the UCI bit to be transmitted and a single PRI.

In operation 1013, the UE may determine a resource for a UL transmission in a first time unit. The first time unit may be a slot or sub-slot. The method for determine the time unit for a UL transmission (e.g., a PUSCH or PUCCH transmission) as described in the foregoing text may apply here. For example, referring to the methods as described with respect to FIGS. 2-5, the UE may determine the first time unit.

In some embodiments of the present disclosure, the UE determining a resource for a UL transmission in a first time unit can be changed into a UE determining the frequency domain location of the resource for a UL transmission in a first time unit. Considering that the time domain locations of the first resource and second resource could be same, so the time domain location of the resource for the UL transmission in the first time unit could be the time domain location, only the frequency domain resource location should be determined.

In some embodiments of the present disclosure, the UE determining the first resource or the second resource is as the resource for the UL transmission in the first time unit means determining the frequency domain location of the first resource, the frequency domain location of the second resource, or a frequency domain location based on those of the first and second resources as the frequency domain location of the resource for the UL transmission in the first time unit.

In some embodiments of the present disclosure, the UE may cancel the UL transmission in the first time unit in the case that the determined resource for the UL transmission in the first time unit overlaps a DL subband or a DL symbol.

In some embodiments of the present disclosure, the UE may receive an indication (denoted as indication #1 for clarity) from the BS, which indicates whether the first resource or the second resource is used for the UL transmission in the first time unit. The UE may determine the resource for the UL transmission in the first time unit based on indication #1.

In some embodiments of the present disclosure, the UE may receive an indication (denoted as indication #1′ for clarity) from the BS, which indicates whether the frequency domain location of the first resource or the frequency domain location of the second resource is used for the UL transmission in the first time unit. The UE may determine the frequency domain location of resource for the UL transmission in the first time unit based on indication #1′.

In some embodiments, indication #1 may indicate that one of the first resource and the second resource is used for a UL transmission per a certain time unit, for example, per slot, per sub-slot, or per symbol. For example, indication #1 may indicate that either the first resource or the second resource should be used for each of a plurality of slots (or a plurality of sub-slots, or a plurality of symbols).

In some embodiments of the present disclosure, the UE may determine the resource for the UL transmission in the first time unit. For example, the UE may determine the resource for the UL transmission in the first time unit according to a condition of the time domain locations in the first time unit, a condition of the first time unit, a format of the time domain locations in the first time unit, or a format of the first time unit. For example, the UE may determine the resource for the UL transmission in the first time unit according to a type(s) of symbol(s) of the time domains locations in the first time unit or a type(s) of symbols of the first time unit.

In some embodiments of the present disclosure, the type of a symbol may include at least one of SBFD, flexible, or UL. The meaning of an SBFD, flexible, or UL symbol as described above may apply here. In some embodiments of the present disclosure, the time domain locations of the first resource and the second resource may be the same.

In some embodiments of the present disclosure, the UE may determine the resource for the UL transmission in the first time unit according to a type(s) of symbol(s) of the time domains locations in the first time unit.

For example, in the case that the type of all symbols of the time domain locations in the first time unit is SBFD, the first resource is determined as the resource for the UL transmission in the first time unit. For example, in the case that the type of all symbols of the time domain locations in the first time unit is UL or flexible, the second resource is determined as the resource for the UL transmission in the first time unit.

In some embodiments of the present disclosure, the type(s) of symbols of the time domain locations of the first resource and the second resource in the first time unit may include one of SBFD, UL, flexible. Put another way, the UE does not expect that any two symbols of time domain locations have different types. That is, the BS should make sure that the indicated time domain locations include only one type of symbol, such as SBFD, UL or flexible.

For example, referring to FIG. 11, a UE may determine frequency domain locations and time domain locations of resource 1101 and resource 1102, wherein resource 1101 can be used for a UL transmission in an SBFD symbol or slot and resource 1102 can be used for a UL transmission in a non-SBFD symbol or slot. The UE may determine a UL transmission in slot #n. As shown in FIG. 11, the time domain locations of resource 1101 and resource 1102 in slot #n include only SBFD symbols. The UE may determine that resource 1101 is used for the UL transmission in slot #n.

In some embodiments of the present disclosure, the type(s) of symbols of the time domain locations in the first time unit may include two or more types. In such embodiments of the present disclosure, various methods may be employed to determine the resource for the UL transmission in the first time unit. Examples of such methods are described below.

For example, in some embodiments of the present disclosure, determining the resource for the UL transmission in the first time unit according to a type(s) of symbol(s) of the time domains locations in the first time unit may include determining one of the first resource and the second resource as the resource for the UL transmission in the first time unit according to a type of a predefined symbol (e.g., the starting or ending symbol) of the time domain locations in the first time unit.

For example, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit.

For example, the predefined symbol is a starting symbol or an ending symbol of the time domain locations of the first resource and the second resources.

For example, it is assumed that the predefined symbol is the starting symbol. In the case that the type of the starting symbol of the time domain resources of the first and second resources in the first time unit is SBFD, the first resource may be used for the UL transmission in the first time unit. In the case that the type of the starting symbol of the time domain resources of the first and second resources in the first time unit is UL or flexible, the second resource may be used for the UL transmission in the first time unit.

For example, referring back to FIG. 8, a UE may determine frequency domain locations and time domain locations of resource 801 and resource 802, wherein resource 801 can be used for a UL transmission in an SBFD symbol or slot and resource 802 can be used for a UL transmission in a non-SBFD symbol or slot. The UE may determine a UL transmission in slot #n. As shown in FIG. 8, the time domain locations of resource 801 and resource 802 in slot #n include SBFD symbols and UL symbols. Since the starting symbol of the time domain locations of resource 801 and resource 802 is an SBFD symbol, the UE may determine that resource 801 is used for the UL transmission in slot #n.

The above method can be similarly applied to the case where the predefined symbol is the ending symbol or any other symbol. For example, in the case that the type of the ending symbol of the time domain resources of the first and second resources in the first time unit is SBFD, the first resource may be used for the UL transmission in the first time unit. In the case that the type of the ending symbol of the time domain resources of the first and second resources in the first time unit is UL or flexible, the second resource may be used for the UL transmission in the first time unit.

For example, in some embodiments of the present disclosure, determining the resource for the UL transmission in the first time unit may include determining the first resource or second resource as the resource for the UL transmission in the first time unit. Put another way, whether the first resource or second resource should be used may be predefined. In some examples, it is preferred that the first resource (i.e., the resource for a UL transmission in an SBFD symbol or slot) is predefined to be used in such scenario.

For example, in some embodiments of the present disclosure, determining the resource for the UL transmission in the first time unit may include determining one of the first resource and the second resource as the resource for the UL transmission in the first time unit according to an indication. An example of such indication is indication #1 as described above.

For example, in some embodiments of the present disclosure, determining the resource for the UL transmission in the first time unit may include determining to cancel the UL transmission in the first time unit. That is, the UE may determine not to transmit the UL transmission in the first time unit.

For example, in some embodiments of the present disclosure, determining the resource for the UL transmission in the first time unit may include determining to transmit repetitions of the UL transmission in the first time unit, wherein the resource for the repetitions includes parts of the first resource and parts of the second resource.

For example, two repetitions of the UL transmission may be transmitted in the first time unit. The first resource is used for transmitting a repetition in SBFD symbols in the first time unit and the second resource is used for transmitting another repetition in UL symbols in the first time unit.

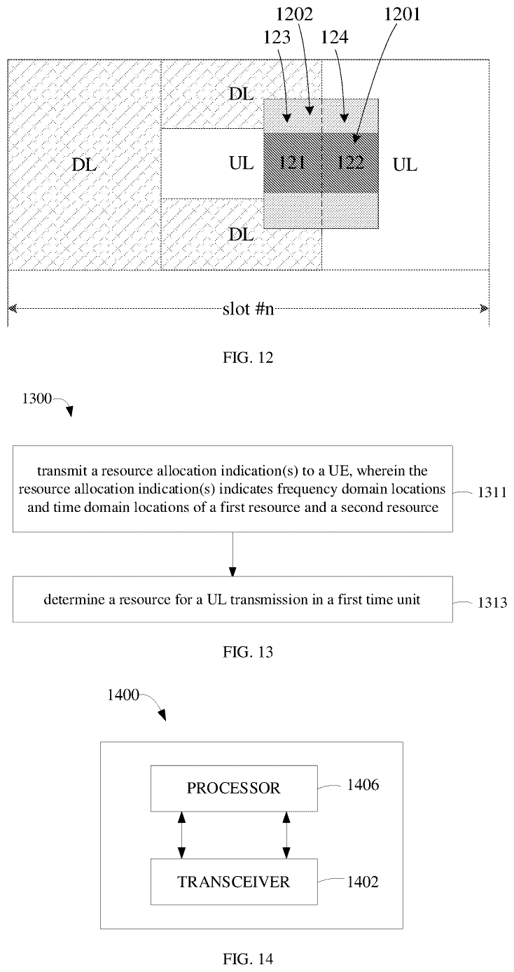

For example, referring to FIG. 12, a UE may determine frequency domain locations and time domain locations of resource 1201 and resource 1202, wherein resource 1201 can be used for a UL transmission in an SBFD symbol or slot and resource 1202 can be used for a UL transmission in a non-SBFD symbol or slot. The UE may determine a UL transmission in slot #n. For example, as shown in FIG. 12, the time domain locations of resource 1201 and resource 1202 in slot #n include SBFD symbols and UL symbols. For examples, the time domain locations of resource 1201 include part 121 with SBFD symbols and part 122 with UL symbols. The time domain locations of resource 1202 include part 123 with SBFD symbols and part 124 with UL symbols. In some embodiments of the present disclosure, the UE may transmit a repetition of the UL transmission in part 121 of resource 1201 in slot #n and another repetition of the UL transmission in part 124 of resource 1202 in slot #n.

For example, in some embodiments of the present disclosure, determining the resource for the UL transmission in the first time unit may include determining that the resource for the UL transmission includes parts of the first resource and parts of the second resource.

For example, the resource for the UL transmission in the first time unit may include two parts. The first part includes the resource for UL transmission in SBFD symbols, and the second part includes the resource for UL transmission in UL symbols. For example, still referring to FIG. 12, the UE may transmit the UL transmission in slot #n using part 121 of resource 1201 and part 124 of resource 1202.

In some embodiments of the present disclosure, the UE may determine the resource for the UL transmission in the first time unit according to a type(s) of symbol(s) of the time domains locations in the first time unit. For example, in some embodiments of the present disclosure, determining the resource for the UL transmission in the first time unit may include determining the first resource as the resource for the UL transmission in the first time unit in the case that there is at least one SBFD symbol within the time domain locations. Otherwise, the second resource is determined as the resource for the UL transmission in the first time unit. In some embodiments of the present disclosure, the time domain locations of the first resource and the second resource may be the same.

For example, referring back to FIG. 8, since there is at least one SBFD symbol within the time domain locations of resources 801 and 802, resource 801 is determined as the resource for the UL transmission in slot #n.

In some embodiments of the present disclosure, determining the resource for the UL transmission in the first time unit may include determining one of the first resource and the second resource as the resource for the UL transmission in the first time unit according to a type of a predefined symbol (e.g., the starting or ending symbol) of the time domain locations in the first time unit.

For example, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit.

For example, the predefined symbol may be a starting symbol of the time domain locations of the first resource and the second resources. In some embodiments of the present disclosure, the starting symbol of the time domain locations of the first resource and the second resources may be the same. For example, the predefined symbol may be an ending symbol of the time domain locations of the first resource and the second resources. In some embodiments of the present disclosure, the ending symbol of the time domain locations of the first resource and the second resources may be the same. The lengths of the time domain locations of the first resource and the second resources can be different or the same.

For example, it is assumed that the predefined symbol is the starting symbol. In the case that the type of the starting symbol of the time domain resources of the first and second resources in the first time unit is SBFD, the first resource may be used for the UL transmission in the first time unit. In the case that the type of the starting symbol of the time domain resources of the first and second resources in the first time unit is UL or flexible, the second resource may be used for the UL transmission in the first time unit. For example, still referring to FIG. 8, since the starting symbol of resource 801 and resource 802 is an SBFD symbol, the UE may determine that resource 801 is used for the UL transmission in slot #n. The above method can be similarly applied to the case where the predefined symbol is the ending symbol or any other symbol.

In some embodiments of the present disclosure, the determined resource for the UL transmission in the first time unit according to a type of a predefined symbol may have the same symbol type (e.g., SBFD, UL, or flexible). Put another way, the UE does not expect that the determined resource for the UL transmission in the first time unit according to a type of a predefined symbol (e.g., the starting or ending symbol) of the time domain locations in the first time unit have different types. That is, the BS should make sure that the determined resource for the UL transmission in the first time unit according to a type of a predefined symbol include only one type of symbol, such as SBFD, UL or flexible.

In some embodiments of the present disclosure, the determined resource for the UL transmission in the first time unit according to a type of a predefined symbol (e.g., the starting or ending symbol) of the time domain locations in the first time unit may have different symbol types. In such embodiments of the present disclosure, various methods may be employed to determine the resource for the UL transmission in the first time unit. Examples of such methods are described below.

For example, in some embodiments of the present disclosure, the UE may determine not to transmit the UL transmission in the first time unit in the case that the determined resource for the UL transmission in the first time unit according to a type of a predefined symbol (e.g., the starting or ending symbol) of the time domain locations in the first time unit has different symbol types.

For example, in some embodiments of the present disclosure, the UE may determine to transmit repetitions of the UL transmission in the first time unit, wherein the resource for the repetitions includes parts of the first resource and parts of the second resource.

For example, two repetitions of the UL transmission may be transmitted in the first time unit. For example, it is assumed that the predefined symbol is the starting symbol. Referring to FIG. 12, since the type of the starting symbol of resource 1201 and resource 1202 in slot #n is SBFD, the UE may determine resource 1201 as the resource for the UL transmission in slot #n. However, since resource 1201 in slot #n includes both SBFD symbols and UL symbols, the UE may determine to transmit two repetitions of the UL transmission in slot #n. In some embodiments of the present disclosure, the UE may transmit a repetition of the UL transmission in part 121 of resource 1201 in slot #n and another repetition of the UL transmission in part 124 of resource 1202 in slot #n.

For example, in some embodiments of the present disclosure, the UE may determine that the resource for the UL transmission in the first time unit includes parts of the first resource and parts of the second resource in the first time unit.

For example, the resource for the UL transmission in the first time unit may include two parts. In some embodiments, the first part of the two parts includes the resource for UL transmission in SBFD symbols, and the second part of the two parts includes the resource for UL transmission in UL symbols. For example, still referring to FIG. 12, the UE may transmit the UL transmission in slot #n using part 121 of resource 1201 and part 124 of resource 1202.

In some embodiments of the present disclosure, determining the resource for the UL transmission in the first time unit may include determining a valid resource from the first resource and the second resource as the resource for the UL transmission in the first time unit.

In some embodiments, the valid resource may be a resource that does not overlap a DL subband or a DL symbol in the first time unit. In some embodiments, the valid resource may not be a dedicated resource for a certain UL transmission.

In some embodiments, the determined resource for the UL transmission in the first time unit may be a resource with more physical resources (e.g., resource elements (REs)) between the first resource and the second resource. In some embodiments, the resource for the UL transmission in the first time unit may be either the first resource or the second resource (for example, as predefined).

In some embodiments, the resource for the UL transmission in the first time unit may be further determined according to a type of a predefined symbol (e.g., the starting or ending symbol) of the time domain locations of the first resource and the second resource. The methods for determining the resource for the UL transmission according to a type of a predefined symbol as described above may apply here. For example, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit. For example, the predefined symbol may be a starting or ending symbol of the time domain locations of the first resource and the second resources.

For example, in the case that both the first resource and the second resource are valid resources, the UE may use the above methods to determine one from the two resources, i.e., the determined one is the one with more physical resources, or is selected according to the type of a predefined symbol of the time domain locations of the first resource and the second resource, or according to a predefined one of the first resource or the second resource.

In some embodiments of the present disclosure, the UE may determine to cancel the UL transmission in the first time unit when neither the first resource nor the second resource in the first time unit is valid.

In some embodiments of the present disclosure, the UE may determine the resource for the UL transmission in the first time unit according to a type(s) of symbols of the first time unit.

For example, in some embodiments of the present disclosure, in the case that a type of at least one symbol of the first time unit is SBFD, the first resource is determined as the resource for the UL transmission in the first time unit. In the case that a type of each symbol of the first time unit is either flexible or UL, the second resource is determined as the resource for the UL transmission in the first time unit.

In some examples, for a PUCCH transmission, the resource allocation indication may indicate two PUCCH resource sets associated with the same number of UCI bits, and one PUCCH resource set (resource set #1) is for PUCCH transmission in SBFD symbols or slots, the other (resource set #2) is for PUCCH transmission in UL symbols or slots. When the UE determines to transmit a PUCCH in a certain time unit and if there is a symbol of this time unit is an SBFD symbol, resource set #1 is used for PUCCH resource determination. That is, the UE may determine a PUCCH resource in resource set #1 based on a PRI. Otherwise, resource set #2 is used for PUCCH resource determination. That is, the UE may determine a PUCCH resource in resource set #2 based on a PRI.

In some examples, for a PUCCH transmission, the resource allocation indication may indicate two PUCCH resources in the same PUCCH resource set associated with the same PRI index. Thus, two PUCCH resources can be indicated by one UCI bit and one PRI. One PUCCH resource (resource #1) is for PUCCH transmission in SBFD symbols or slots, the other (resource #2) is for PUCCH transmission in UL symbols or slots. When the UE determines to transmit in a certain time unit and if there is a symbol of this time unit is an SBFD symbol, resource #1 is used for the PUCCH transmission. Otherwise, resource #2 is used for the PUCCH transmission.

For example, in some embodiments of the present disclosure, the first time unit may include one symbol type. That is, each symbol of the first time unit is an SBFD, UL, or flexible symbol. In the case that the type of symbols of the first time unit is SBFD, the first resource is determined as the resource for the UL transmission in the first time unit. In the case that the type of symbols of the first time unit is either flexible or UL, the second resource is determined as the resource for the UL transmission in the first time unit.

In some embodiments of the present disclosure, the UL transmission in the first time unit is a repetition for a certain UL transmission. For example, the certain UL transmission may be transmitted in a plurality of repetitions in respective time units (e.g., including the first time unit). The above methods for determining the resource for the UL transmission in the first time unit may be applied to each repetition of the plurality of repetitions.

In some embodiments of the present disclosure, the UL transmission is a first repetition for a certain UL transmission, and the processor is further configured to determine that a resource for a repetition of the certain UL transmission in a following time unit is same as the resource for the UL transmission in the first time unit. For example, the certain UL transmission may be transmitted in a plurality of repetitions in respective time units (e.g., including the first time unit). The above methods for determining the resource for the UL transmission in the first time unit may be applied to a specific repetition (e.g., the initial repetition) of the plurality of repetitions. The resources for transmitting the remaining repetitions of the plurality of repetitions within the respective time unit may have the same frequency and time domain allocations as the resource for transmitting the specific repetition in the corresponding time unit.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 13 illustrates a flow chart of an exemplary procedure 1300 for determining a resource for a UL transmission in accordance with some embodiments of the present disclosure. Procedure 1300 may be implemented by a network entity (e.g., BS 102 as shown in FIG. 1). Details described in all of the foregoing embodiments of the present disclosure are applicable for the embodiments shown in FIG. 13.

Referring to FIG. 13, in operation 1311, a BS may transmit a resource allocation indication(s) to a UE, wherein the resource allocation indication(s) indicates frequency domain locations and time domain locations of a first resource and a second resource.

In some embodiments of the present disclosure, the UL transmission may be a PUSCH transmission or a PUCCH transmission. The descriptions regarding the resource allocation indication(s) in the foregoing embodiments may apply here. In some embodiments of the present disclosure, the time domain locations of the first resource and the second resource may be the same or different.

In some embodiments of the present disclosure, the first resource is for a UL transmission in an SBFD symbol or slot and the second resource is for a UL transmission in a non-SBFD symbol or slot. The above descriptions with respect to the first and second resources may apply here.

In operation 1313, the BS may determine a resource for a UL transmission in a first time unit. The first time unit may be a slot or sub-slot. The method for determine the time unit for a UL transmission (e.g., a PUSCH or PUCCH transmission) as described in the foregoing text may apply here. For example, referring to the methods as described with respect to FIGS. 2-5, the BS may determine the first time unit.

The methods for determining the resource for the UL transmission in the first time unit as described with respect to FIG. 10 may apply here.

For example, in some embodiments of the present disclosure, the BS may transmit an indication (e.g., indication #1) to the UE, which indicates whether the first resource or the second resource is used for the UL transmission in the first time unit. The BS may determine the resource for the UL transmission in the first time unit based on indication #1.

For example, in some embodiments of the present disclosure, the BS may determine the resource for the UL transmission in the first time unit. For example, the BS may determine the resource for the UL transmission in the first time unit according to a condition of the time domain locations in the first time unit, a condition of the first time unit, a format of the time domain locations in the first time unit, or a format of the first time unit. For example, the BS may determine the resource for the UL transmission in the first time unit according to a type(s) of symbol(s) of the time domains locations in the first time unit or a type(s) of symbols of the first time unit.

In some embodiments of the present disclosure, the type of a symbol may include at least one of SBFD, flexible, or UL. In some embodiments of the present disclosure, the time domain locations of the first resource and the second resource may be the same.

In some embodiments of the present disclosure, the BS may determine the resource for the UL transmission in the first time unit according to a type(s) of symbol(s) of the time domains locations in the first time unit.

For example, in the case that the type of all symbols of the time domain locations in the first time unit is SBFD, the first resource is determined as the resource for the UL transmission in the first time unit. For example, in the case that the type of all symbols of the time domain locations in the first time unit is UL or flexible, the second resource is determined as the resource for the UL transmission in the first time unit.

In some embodiments of the present disclosure, the type(s) of symbols of the time domain locations of the first resource and the second resource in the first time unit may include one of SBFD, UL, flexible. Put another way, the BS should make sure that the indicated time domain locations include only one type of symbol, such as SBFD, UL or flexible.

In some embodiments of the present disclosure, the type(s) of symbols of the time domain locations in the first time unit may include two or more types. Various methods for determining the resource for the UL transmission in the first time unit in such scenario as described above with respect to FIG. 10 may apply here.

For example, in some embodiments of the present disclosure, determining the resource for the UL transmission in the first time unit according to a type(s) of symbol(s) of the time domains locations in the first time unit may include one of the following: determining one of the first resource and the second resource as the resource for the UL transmission in the first time unit according to a type of a predefined symbol (e.g., the starting or ending symbol) of the time domain locations in the first time unit; determining the first resource or second resource as the resource for the UL transmission in the first time unit; determining one of the first resource and the second resource as the resource for the UL transmission in the first time unit according to a second indication; determining that the UL transmission in the first time unit is canceled; determining to receive repetitions of the UL transmission in the first time unit, wherein the resource for the repetitions includes parts of the first resource and parts of the second resource; and determining the resource for the UL transmission include parts of the first resource and parts of the second resource.

In some embodiments of the present disclosure, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit. In some embodiments of the present disclosure, the predefined symbol is a starting symbol or an ending symbol of the time domain locations of the first resource and the second resources.

In some embodiments of the present disclosure, determining the resource for the UL transmission in the first time unit may include determining the first resource as the resource for the UL transmission in the first time unit in the case that there is at least one SBFD symbol within the time domain locations. Otherwise, the second resource is determined as the resource for the UL transmission in the first time unit. In some embodiments of the present disclosure, the time domain locations of the first resource and the second resource may be the same.

In some embodiments of the present disclosure, determining the resource for the UL transmission in the first time unit may include determining one of the first resource and the second resource as the resource for the UL transmission in the first time unit according to a type of a predefined symbol (e.g., the starting or ending symbol) of the time domain locations in the first time unit.

For example, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit. In some embodiments of the present disclosure, the predefined symbol is a starting symbol or an ending symbol of the time domain locations of the first resource and the second resources.

In some embodiments of the present disclosure, determining the resource for the UL transmission in the first time unit may include determining a valid resource from the first resource and the second resource as the resource for the UL transmission in the first time unit.

In some embodiments, the valid resource may be a resource that does not overlap a DL subband or a DL symbol in the first time unit. In some embodiments, the valid resource may not be a dedicated resource for a certain UL transmission.

In some embodiments, the determined resource for the UL transmission in the first time unit is one of the followings: a resource with more physical resources (e.g., REs) between the first resource and the second resource; a determined resource according to a type of a predefined symbol of the time domain locations of the first resource and the second resource; or the first resource or the second resource.

The methods for determining the resource for the UL transmission according to a type of a predefined symbol as described above may apply here. For example, in the case that the type of the predefined symbol is SBFD, the first resource is determined as the resource for the UL transmission in the first time unit. In the case that the type of the predefined symbol is UL or flexible, the second resource is determined as the resource for the UL transmission in the first time unit. For example, the predefined symbol may be a starting or ending symbol of the time domain locations of the first resource and the second resources.

For example, in the case that both the first resource and the second resource are valid resources, the BS may use the above methods to determine one from the two resources, i.e., the determined one is the one with more physical resources, or is selected according to the type of a predefined symbol of the time domain locations of the first resource and the second resource, or according to a predefined one of the first resource or the second resource.

In some embodiments of the present disclosure, the BS may determine that the UL transmission in the first time unit is canceled when neither the first resource nor the second resource in the first time unit is valid.

In some embodiments of the present disclosure, the UE may determine the resource for the UL transmission in the first time unit according to a type(s) of symbols of the first time unit.

For example, in some embodiments of the present disclosure, in the case that a type of at least one symbol of the first time unit is SBFD, the first resource is determined as the resource for the UL transmission in the first time unit. In the case that a type of each symbol of the first time unit is either flexible or UL, the second resource is determined as the resource for the UL transmission in the first time unit.

For example, in some embodiments of the present disclosure, the type(s) of symbols of the first time unit includes one of SBFD, UL, flexible. That is, each symbol of the first time unit is an SBFD, UL, or flexible symbol. In the case that the type of symbols of the first time unit is SBFD, the first resource is determined as the resource for the UL transmission in the first time unit. In the case that the type of symbols of the first time unit is either flexible or UL, the second resource is determined as the resource for the UL transmission in the first time unit.

In some embodiments of the present disclosure, the UL transmission in the first time unit is a repetition for a certain UL transmission. In some embodiments of the present disclosure, the UL transmission is a first repetition for a certain UL transmission, and the processor is further configured to determine that a resource for a repetition of the certain UL transmission in a following time unit is same as the resource for the UL transmission in the first time unit.

In some embodiments of the present disclosure, the BS may determine that the UL transmission in the first time unit is canceled in the case that the determined resource for the UL transmission in the first time unit overlaps a DL subband or a DL symbol.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

FIG. 14 illustrates a block diagram of an exemplary apparatus 1400 according to some embodiments of the present disclosure. As shown in FIG. 14, the apparatus 1400 may include at least one processor 1406 and at least one transceiver 1402 coupled to the processor 1406. The apparatus 1400 may be a UE or a network entity such as a BS.

Although in this figure, elements such as the at least one transceiver 1402 and processor 1406 are described in the singular, the plural is contemplated unless a limitation to the singular is explicitly stated. In some embodiments of the present application, the transceiver 1402 may be divided into two devices, such as a receiving circuitry and a transmitting circuitry. In some embodiments of the present application, the apparatus 1400 may further include an input device, a memory, and/or other components.

In some embodiments of the present application, the apparatus 1400 may be a UE. The transceiver 1402 and the processor 1406 may interact with each other so as to perform the operations with respect to the UE described in FIGS. 1-13. In some embodiments of the present application, the apparatus 1400 may be a BS. The transceiver 1402 and the processor 1406 may interact with each other so as to perform the operations with respect to the BS described in FIGS. 1-13.

In some embodiments of the present application, the apparatus 1400 may further include at least one non-transitory computer-readable medium.

For example, in some embodiments of the present disclosure, the non-transitory computer-readable medium may have stored thereon computer-executable instructions to cause the processor 1406 to implement the method with respect to the UE as described above. For example, the computer-executable instructions, when executed, cause the processor 1406 interacting with transceiver 1402 to perform the operations with respect to the UE described in FIGS. 1-13.

In some embodiments of the present disclosure, the non-transitory computer-readable medium may have stored thereon computer-executable instructions to cause the processor 1406 to implement the method with respect to the BS as described above. For example, the computer-executable instructions, when executed, cause the processor 1406 interacting with transceiver 1402 to perform the operations with respect to the BS described in FIGS. 1-13.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a base station (BS), one or more resource allocation indications that indicate frequency domain locations and time domain locations of a first resource and a second resource; and
determine a resource for an uplink (UL) transmission in a first time unit according to a type of one or more symbols of the time domain locations in the first time unit or one or more types of symbols of the first time unit.

2. The UE of claim 1, wherein the type of one or more symbols comprises at least one of subband full duplex (SBFD), flexible, or UL.

3. The UE of claim 1, wherein:
if the type of all symbols of the time domain locations in the first time unit is subband full duplex (SBFD), then the first resource is determined as the resource for the UL transmission in the first time unit; or
if the type of all symbols of the time domain locations in the first time unit is UL or flexible, then the second resource is determined as the resource for the UL transmission in the first time unit.

4. The UE of claim 1, wherein, if the type of the one or more symbols of the time domain locations in the first time unit includes two or more types, the at least one processor is configured to cause the UE to determine the resource for the UL transmission in the first time unit according to the type of the one or more symbols of the time domain locations in the first time unit based on one of:
determine one of the first resource and the second resource as the resource for the UL transmission in the first time unit according to a type of a predefined symbol of the time domain locations in the first time unit;
determine the first resource or second resource as the resource for the UL transmission in the first time unit;
determine one of the first resource and the second resource as the resource for the UL transmission in the first time unit according to a second indication;
determine to cancel the UL transmission in the first time unit;
determine to transmit repetitions of the UL transmission in the first time unit, wherein the resource for the repetitions includes parts of the first resource and parts of the second resource; and
determine the resource for the UL transmission includes parts of the first resource and parts of the second resource.

5. The UE of claim 1, wherein if there is at least one subband full duplex (SBFD) symbol within the time domain locations, then the first resource is determined as the resource for the UL transmission in the first time unit; otherwise, the second resource is determined as the resource for the UL transmission in the first time unit.

6. The UE of claim 1, wherein, to determine the resource for the UL transmission in the first time unit according to the type of the one or more symbols of the time domain locations in the first time unit, the at least one processor is configured to cause the UE to:
determine one of the first resource or the second resource as the resource for the UL transmission in the first time unit according to a type of a predefined symbol of the time domain locations in the first time unit.

7. The UE of claim 1, wherein the one or more types of the symbols of the time domain locations of the first resource and the second resource includes one of subband full duplex (SBFD), UL, or flexible.

8. The UE of claim 1, wherein, to determine the resource for the UL transmission in the first time unit, the at least one processor is configured to cause the UE to determine a valid resource from the first resource and the second resource as the resource for the UL transmission in the first time unit.

9. The UE of claim 8, wherein the valid resource is a resource that does not overlap a downlink (DL) subband or a DL symbol in the first time unit, or is not a dedicated resource for an UL transmission.

10-13. (canceled)

14. A user equipment (UE) for wireless communication, comprising:
at least one memory; and
at least one processor coupled with the at least one memory and configured to cause the UE to:
receive, from a base station, one or more resource allocation indications that indicate frequency domain locations and time domain locations of a first resource and a second resource; and
receive, from a base station, a second indication that indicates whether the first resource or the second resource is used for an uplink (UL) transmission in a first time unit.

15. A base station (BS) for wireless communication, comprising:
at least one memory; and
at least one processor coupled with the at least one memory and configured to cause the BS to:
transmit, to a user equipment (UE), one or more resource allocation indications that indicate frequency domain locations and time domain locations of a first resource and a second resource; and
determine a resource for an uplink (UL) transmission in a first time unit according to a type of one or more symbols of the time domain locations in the first time unit or one or more types of symbols of the first time unit.

16. The UE of claim 1, wherein the UL transmission is a physical uplink shared channel (PUSCH) transmission.

17. The UE of claim 1, wherein:
the UL transmission is a physical uplink control channel (PUCCH) transmission;
the one or more resource allocation indications indicate a single time domain location and two frequency domain locations for a single PUCCH configuration; and
the first resource and the second resource share a same time domain location and correspond to respective frequency domain locations.

18. The UE of claim 1, wherein the at least one processor is configured to cause the UE to receive, from the BS, an indication of whether the first resource or the second resource is used for the UL transmission in the first time unit.

19. The UE of claim 1, wherein the UL transmission in the first time unit is a repetition for a certain UL transmission.

20. The UE of claim 1, wherein the UL transmission is a first repetition for a certain UL transmission, and the at least one processor is configured to cause the UE to determine that a resource for a repetition of the certain UL transmission in a following time unit is a same resource as for the UL transmission in the first time unit.

21. The UE of claim 1, wherein the first resource is for an UL transmission in a subband full duplex (SBFD) symbol or slot, and the second resource is for an UL transmission in a non-SBFD symbol or slot.

22. The UE of claim 1, wherein the UE does not expect that any two symbols of the time domain locations have different types.

23. The UE of claim 4, wherein the at least one processor is configured to cause the UE to transmit two repetitions of the UL transmission in the first time unit, wherein the first resource is used to transmit a repetition in subband full duplex (SBFD) symbols in the first time unit and the second resource is used to transmit another repetition in UL symbols in the first time unit.

24. The UE of claim 1, wherein the time domain locations of the first resource and the second resource are a same time domain location.
